(19) United States
(12) Patent Application Publication
(10) Pub. No.: US 2025/0323789 A1
(43) Pub. Date: Oct. 16, 2025

(54) SECURE DEVICE ACCESS AND MODULE LOADING USING AUTHORIZATION TOKEN

(71) Applicant: Roku, Inc., San Jose, CA (US)

(72) Inventors: Timothy Howard White, Thrall, TX (US); Muhammad Israr Khan, Santa Clara, CA (US); Khoa Hoang, San Jose, CA (US); Anirudh Joshi, San Jose, CA (US); Scott Allen Brown, Los Gatos, CA (US)

(73) Assignee: Roku, Inc., San Jose, CA (US)

(21) Appl. No.: 18/634,492

(22) Filed: Apr. 12, 2024

(51) Int. Cl. H04L 9/32

(52) U.S. Cl. CPC H04L 9/3213; H04L 9/3226

(57) ABSTRACT

Disclosed herein are system, apparatus, article of manufacture, method and/or computer program product embodiments, and/or combinations and sub-combinations thereof, for securely loading a module on a secure device. An example embodiment operates by receiving, from the first entity, a request to load the module prepared by a second entity on the secure device. The embodiment then receives a password from the first entity. The embodiment then determines the password matches a password identifier in an authorization token stored on the secure device. The embodiment then retrieves a public key from the secure device based on a public key identifier in the authorization token. The embodiment then verifies a cryptographic signature of the module using the public key. The embodiment then decrypts an encrypted symmetric key in the authorization token. The embodiment then decrypts the module using the symmetric key. The embodiment then loads the module onto the secure device.

### FIELD

This disclosure is generally directed to managing access to functions in secure devices, and more particularly to loading modules on secure devices.

### SUMMARY

Provided herein are system, apparatus, article of manufacture, method and/or computer program product embodiments, and/or combinations and sub-combinations thereof, for managing access to functions in secure devices, and for allowing a first entity (e.g., user) to securely loading a module prepared by a second entity (e.g., user) on a secure device.

An example embodiment operates by a computer-implemented method. The method includes receiving, by at least one computer processor at a secure device from the first entity, a request to load the module prepared by the second entity on the secure device. The method further includes, in response to receiving the request, receiving a password from the first entity to load the module on to the secure device. The method further includes determining the password matches a password identifier in an authorization token stored on the secure device. The method further includes, in response to determining the password matches the password identifier in the authorization token, retrieving a public key from the secure device based on a public key identifier in the authorization token. The method further includes verifying a cryptographic signature of the module using the public key. The method further includes, in response to verifying the cryptographic signature of the module, decrypting an encrypted symmetric key in the authorization token using one or more secrets on the secure device, thereby producing a symmetric key. The method further includes decrypting the module using the symmetric key. The method further includes loading the module onto the secure device.

An example embodiment operates by a system including one or more memories and at least one processor each coupled to at least one of the memories. The at least one processor is configured to perform operations including receiving, from the first entity, a request to load the module prepared by the second entity on the secure device. The operations further include, in response to receiving the request, receiving a password from the first entity to load the module on to the secure device. The operations further include determining the password matches a password identifier in an authorization token stored on the secure device. The operations further include, in response to determining the password matches the password identifier in the authorization token, retrieving a public key from the secure device based on a public key identifier in the authorization token. The operations further include verifying a cryptographic signature of the module using the public key. The operations further include, in response to verifying the cryptographic signature of the module, decrypting an encrypted symmetric key in the authorization token using one or more secrets on the secure device, thereby producing a symmetric key. The operations further include decrypting the module using the symmetric key. The operations further include loading the module onto the secure device.

An example embodiment operates by a non-transitory computer-readable medium having instructions stored thereon that, when executed by at least one computing device, cause the at least one computing device to perform operations. The operations include receiving, from the first entity, a request to load the module prepared by the second entity on the secure device. The operations further include, in response to receiving the request, receiving a password from the first entity to load the module on to the secure device. The operations further include determining the password matches a password identifier in an authorization token stored on the secure device. The operations further include, in response to determining the password matches the password identifier in the authorization token, retrieving a public key from the secure device based on a public key identifier in the authorization token. The operations further include verifying a cryptographic signature of the module using the public key. The operations further include, in response to verifying the cryptographic signature of the module, decrypting an encrypted symmetric key in the authorization token using one or more secrets on the secure device, thereby producing a symmetric key. The operations further include decrypting the module using the symmetric key. The operations further include loading the module onto the secure device.

Further features and advantages of embodiments, as well as the structure and operation of various embodiments, are described in detail below with reference to the accompanying drawings. It is noted that the embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a streaming media device, according to some embodiments.

FIG. 3 illustrates a block diagram of secure device access environment, according to some embodiments.

FIG. 4 is a flowchart of a process for requesting and loading an authorization token onto a secure device to facilitate access to a secure device function and/or loading a module, according to some embodiments.

FIG. 5 is a flowchart of a process for allowing a first entity to load a module prepared by a second entity on a secure device, according to some embodiments.

FIG. 6 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for allowing field and quality assurance engineers load a module on a secure device without allowing another user to access secure functions or load another module on the secure device if the secure device is lost or stolen.

Manufacturers and developers often need to let field and quality assurance engineers test and fix hardware and software in the field. Manufacturers and developers often let field and quality assurance engineers test and fix issues in the field by loading modules on a secure device. However, loading modules on the secure device is often blocked for security reasons.

Manufacturers want to give their engineers the ability to load modules on a secure device to fix issues but also need to restrict access to the secure device maintain security. They are worried that too much access could let competitors exploit the secure device or reveal sensitive information. For example, manufacturers often want to make sure that granting access to loading development modules doesn't lead to unrestricted access later by unauthorized individuals (e.g., after the field engineer has switched the secure device to an unsecured state and completed loading the development module). They worry that if the secure device is lost or stolen, competitors or others could get access to secrets in a development module using industry-standard tools, since development modules are typically the same as production-built images for a secure device.

So, manufacturers often face two choices. One, they can stop field and quality assurance engineers from loading development modules on the secure device for testing and troubleshooting (e.g., by blocking the use of production keys for signing and encrypting such development modules). Or two, they can allow the development modules to be loaded without being signed and encrypted, which could expose secrets in the module to unauthorized individuals.

Embodiments herein solve these technological problems through an authorization token mechanism that can ensure that only a single person (e.g., a quality assurance engineer) can load a module prepared by a developer even if the secure device ends up being lost or stolen. In other words, the authorization token mechanism provides a unique two-factor authentication mechanism: only a single person who holds a secret (e.g., a password, PIN, or other type of secret as would be appreciated by a person of ordinary skill in the art) associated with the authorization token can load modules from a developer, and a public key infrastructure (PKI) associated with the authorization token controls from what developers the single person can load modules from.

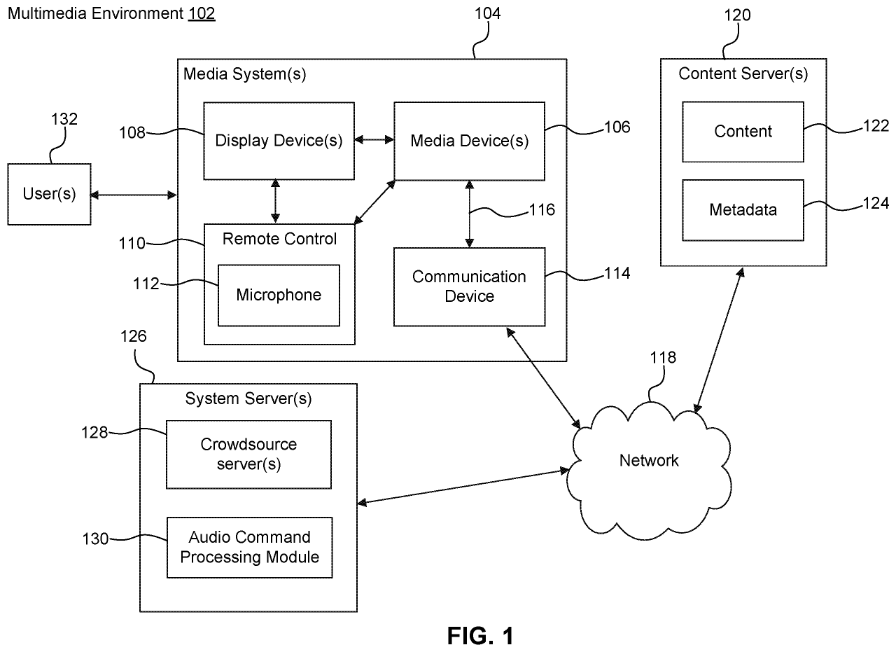

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some embodiments, media device 106 can be a part of, integrated with, operatively coupled to, and/or connected to its respective display device 108.

Each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as WiFi) and/or wired connections.

In various embodiments, the network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 106 and/or display device 108, such as a remote control, a tablet, laptop computer, smartphone, wearable, on-screen controls, integrated control buttons, audio controls, or any combination thereof, to name just a few examples. In an embodiment, the remote control 110 wirelessly communicates with the media device 106 and/or display device 108 using cellular, Bluetooth, infrared, etc., or any combination thereof. The remote control 110 may include a microphone 112, which is further described below.

The multimedia environment 102 may include a plurality of content servers 120 (also called content providers, channels or sources 120). Although only one content server 120 is shown in FIG. 1, in practice the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form.

In some embodiments, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126.

The media devices 106 may exist in thousands or millions of media systems 104. Accordingly, the media devices 106 may lend themselves to crowdsourcing embodiments and, thus, the system servers 126 may include one or more crowdsource servers 128.

For example, using information received from the media devices 106 in the thousands and millions of media systems 104, the crowdsource server(s) 128 may identify similarities and overlaps between closed captioning requests issued by different users 132 watching a particular movie. Based on such information, the crowdsource server(s) 128 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, the crowdsource server(s) 128 may operate to cause closed captioning to be automatically turned on and/or off during future streaming of the movie.

The system servers 126 may also include an audio command processing module 130. As noted above, the remote control 110 may include a microphone 112. The microphone 112 may receive audio data from users 132 (as well as other sources, such as the display device 108). In some embodiments, the media device 106 may be audio responsive, and the audio data may represent verbal commands from the user 132 to control the media device 106 as well as other components in the media system 104, such as the display device 108.

In some embodiments, the audio data received by the microphone 112 in the remote control 110 is transferred to the media device 106, which is then forwarded to the audio command processing module 130 in the system servers 126. The audio command processing module 130 may operate to process and analyze the received audio data to recognize the user 132's verbal command. The audio command processing module 130 may then forward the verbal command back to the media device 106 for processing.

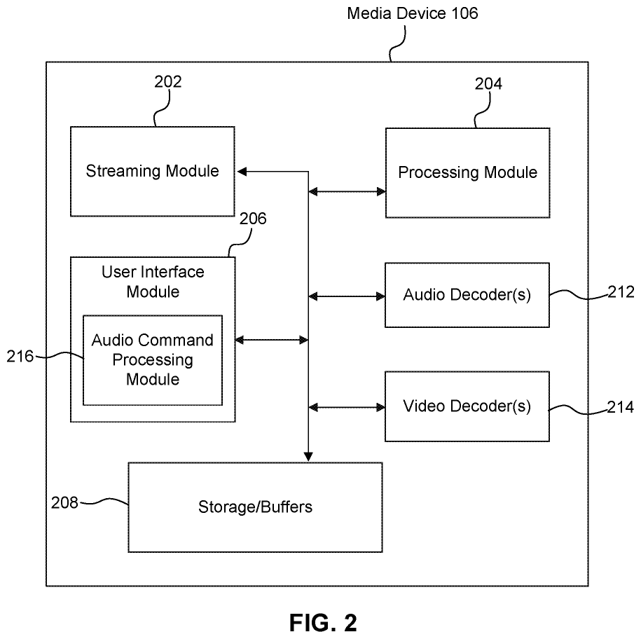

In some embodiments, the audio data may be alternatively or additionally processed and analyzed by an audio command processing module 216 in the media device 106 (see FIG. 2). The media device 106 and the system servers 126 may then cooperate to pick one of the verbal commands to process (either the verbal command recognized by the audio command processing module 130 in the system servers 126, or the verbal command recognized by the audio command processing module 216 in the media device 106).

FIG. 2 illustrates a block diagram of an example media device 106, according to some embodiments. Media device 106 may include a streaming module 202, processing module 204, storage/buffers 208, and user interface module 206. As described above, the user interface module 206 may include the audio command processing module 216.

The media device 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OPla, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some embodiments, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming module 202 of the media device 106 may request the selected content from the content server(s) 120 over the network 118. The content server(s) 120 may transmit the requested content to the streaming module 202. The media device 106 may transmit the received content to the display device 108 for playback to the user 132.

In streaming embodiments, the streaming module 202 may transmit the content to the display device 108 in real time or near real time as it receives such content from the content server(s) 120. In non-streaming embodiments, the media device 106 may store the content received from content server(s) 120 in storage/buffers 208 for later playback on display device 108.

### Secure Device Access And Module Loading Using Authorization Token

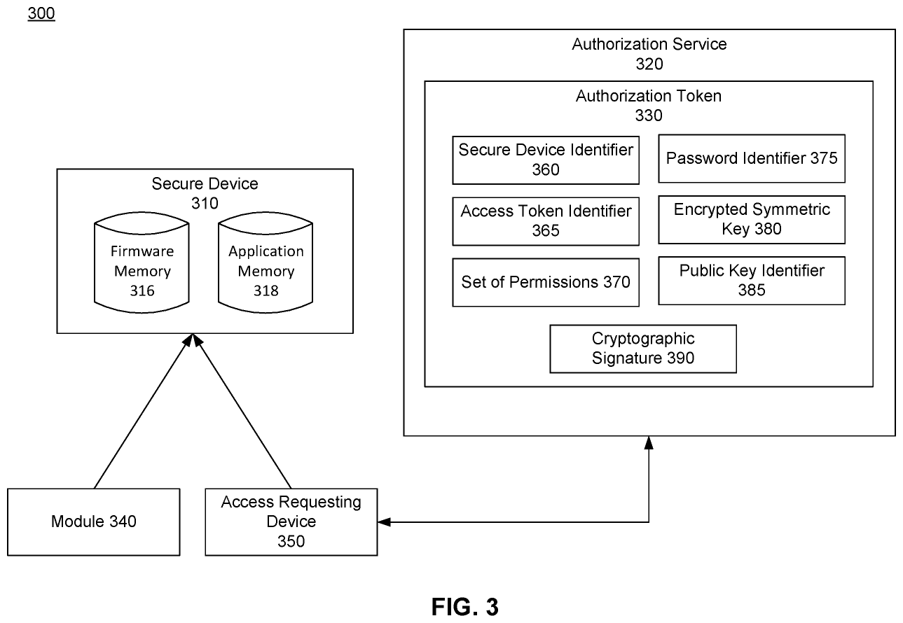

FIG. 3 depicts a block diagram of a secure device access environment 300, according to some embodiments. Secure device access environment 300 utilizes an authorization token mechanism that can ensure that only a single entity (e.g., a quality assurance engineer) can load a module (e.g., module 340) prepared by a specific second entity (e.g., a developer) onto a secure device (e.g., secure device 310) even if the secure device ends up being lost or stolen. In other words, the authorization token mechanism provides a unique two-factor authentication mechanism: only a single entity (e.g., user) who holds a secret (e.g., a password, PIN, or other type of secret as would be appreciated by a person of ordinary skill in the art) associated with an authorization token (e.g., authorization token 330) can load modules from a second entity (e.g., a developer), and a PKI associated with the authorization token controls from what entities the single entity can load modules from. While the below description often describes loading a development module onto a secure device (as opposed to a production module), a person of ordinary skill in the art would understand that the authorization token mechanism described herein may also load a production module onto a secure device.

The secure device access environment 300 may include a secure device 310, an authorization service 320, an access requesting device 350, and a module 340. Access requesting device 350 may be communicatively coupled to secure device 310. Access requesting device 350 may also be communicatively coupled to authorization service 320.

Module 340 may be a software module. Module 340 may also be a hardware module or firmware module. Secure device 310 may be updated to perform one or more functions using module 340. For example, secure device 310 may be updated by loading module 340 into firmware memory 316. Secure device 310 may also be updated by loading module 340 into application memory 318.

Secure device 310 may be a computing device that includes a firmware architecture. Secure device 310 may range from a general-purpose computer to application specific hardware or an application specific device. For example, secure device 310 may be a mobile phone, a tablet computer, a laptop computer, a television, a streaming media device, a media player device, a gaming console, an Internet service device such as a router or modem, an IoT device, a clock, a camera, a wearable electronic device such as a smart watch, a printer, a scanner, and/or other devices that include firmware. Secure device 310 may be a media device 104 in FIG. 1. Secure device 310 may be a remote control 110 in FIG. 1. Secure device 310 may be another type of electronic device as would be appreciated by a person of ordinary skill in the art.

Secure device 110 may include one or more processors, memory, servers, routers, modems, antennae, input and/or output interfaces, hardware connectors, such as for example, Universal Serial Bus (USB) connectors, ports, and/or other communication hardware configured to communicate with access requesting device 350. Access requesting device 350 may be a computing device that provides an authorization token 330 to secure device 310 in an attempt to access firmware-locked functions and/or load a module 340 into firmware memory 316 of secure device 310. Based on the applications, functions, and/or design of secure device 310, secure device 310 may include various hardware components to implement the desired functionality.

Secure device 310 may include firmware memory 316. Firmware memory 316 may include volatile and/or non-volatile memory, such as read-only memory (ROM), erasable programmable read-only memory (EPROM), and/or flash memory. Firmware memory 316 may store low-level instructions and/or programs utilize to operate secure device 310. For example, firmware memory 316 may provide an operating environment for other software programs and/or may provide an operating system to be utilized by secure device 310. Firmware memory 316 may provide a basic input/output system (BIOS) and/or provide other hardware initialization processes for booting runtime services for operating systems and/or programs.

Different configurations of secure device 310 may utilize different firmware programs stored in firmware memory 316. For example, in some embodiments, where secure device 310 requires less complex computing functionality, firmware memory 316 may not include functionality to support additionally application program functionality. In other embodiments, where secure device 310 utilizes a more complex computing configuration, firmware memory 316 may include more complex firmware programs configured to support and/or service application programs.

Secure device 310 may include application memory 316. Application memory 316 may include application programs that utilize firmware programs or functions stored in firmware memory 316.

To illustrate, in an embodiment, secure device 310 may be a remote control (e.g., remote control 110 in FIG. 1) used to send commands to a display device (e.g., display device 108 in FIG. 1) or a wireless streaming system. If secure device 310 is limited in functions (e.g., limited to the transmission of commands), the firmware program stored in firmware memory 316 may be less extensive compared to other types of secure devices 310. For example, if secure device 310 is a smart watch configured to measure data from biometric sensors, process the measured data, display the measured data using a graphical user interface, and/or communicate with a remote computing system via a wireless communication interface, the firmware program stored in firmware memory 316 may be more complex.

While the complexity of the firmware program may vary, a common feature among different types of secure devices 310 may be that the firmware program and/or the firmware memory 316 may be inaccessible to users of secure device 310. For example, secure device 310 may be production hardware that may grant access to application programs and/or application software but may not grant access to the firmware program and/or firmware memory 316. Firmware programs may be more sensitive than applications programs because access to firmware programs may grant access to locked functions of secure device 310. For example, a user or system with access to the firmware program may read sensitive information stored in secure device 310, control the functions of secure device 310, and/or load malicious programs onto secure device 310. Similarly, a user or system may hack, tamper with, and/or reverse engineer programs stored in secure device 310 via firmware program access.

Due to the sensitive nature of programs stored in firmware memory 316, proprietors and/or manufacturers may wish to restrict access to firmware memory 316. The proprietors may wish to grant limited access to select authorized individuals and/or systems, allowing access to firmware memory 316. For example, proprietors may wish to allow technicians to access fault information stored in firmware memory 316 to debug problems or errors associated with secure device 310. Similarly, proprietors may wish to allow technicians to manipulate low-level hardware functions of secure device 310 for debugging problems, testing for quality assurance purposes, and/or for developing new functions and/or programs for the secure device 310. Similarly, proprietors may wish to allow technicians to update firmware software and/or application software stored in the secure device 310. For example, proprietors and/or manufacturers may wish to allow quality assurance engineers or other technicians to load a module (e.g., module 340) into firmware memory 316 and/or application memory 318.

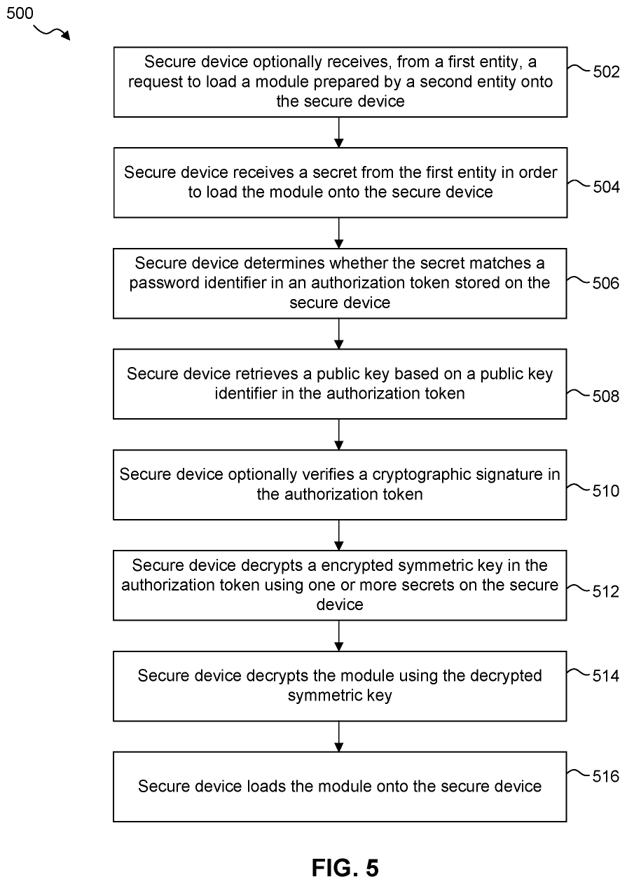

To allow certain individuals and/or systems to access firmware-locked functions and/or load modules into firmware memory 316 and/or application memory 318, secure device 310 may utilize authorization tokens 330. Access requesting device 350 may provide authorization tokens 330 to secure device 310 in an attempt to access firmware-locked functions and/or load modules in firmware memory 316 and/or application memory 318. FIG. 5 (discussed below) provides example embodiments of how this loading of a module may occur.

While manufacturers often want to give field engineers and quality assurance engineers the ability to load a module 340 into firmware memory 316 and/or application memory 318 on secure device 310, they also want to restrict access to maintain security. In particular, while manufacturers want to give field engineers and quality assurance engineers the ability to load a module 340 into firmware memory 316 of secure device 310, they are worried that doing so could let competitors exploit secure device 310 or reveal sensitive information. Manufacturers also want to make sure that granting access to loading a module 340 into firmware memory 316 of secure device 310 doesn't lead to unrestricted access later by unauthorized individuals (e.g., after the quality assurance engineer has switched secure device 310 to an unsecured state and completed loading the module 340). Manufacturers worry that if the secure device 310 is lost or stolen, competitors or others could get access to secrets in the module 340 using industry-standard tools. This is often the case with development modules since they are typically the same as production-built images for secure device 310. Embodiments herein solve these technological problems through the use of an authorization token 330 that allows manufacturers to give field engineers and quality assurance engineers the ability to load a module 340 into firmware memory 316 of secure device 310 without it leading to unrestricted access later by unauthorized individuals.

To illustrate a process of enabling a field engineer or quality assurance engineer to load a module 340 into firmware memory 316 and/or application memory 318 of secure device 310, the field engineer or quality assurance engineer can first request an authorization token 330 from authorization service 320. Authorization service 320 may be a computing device that generates an authorization token 330 with various characteristics as described below. Authorization service 320 may a server computer, cloud computing platform, cluster, or other type of computing device as would be appreciated by a person of ordinary skill in the art.

Authorization token 330 may by a data object or data element passed from access requesting device 350 to secure device 310. In some embodiments, for example, authorization token 330 may include a structure similar to a JavaScript Object Notation (JSON) Web Token. Authorization token 330 may be implemented using a JSON data structure or other data structure type as would be appreciated by a person of ordinary skill in the art.

Authorization token 330 can be specific to the requesting field engineer, quality assurance engineer, or other type of system or entity who is loading a module 340 prepared by a particular developer or other type of system or entity. For example, a field engineer (Bob) who tests and/or troubleshoots secure device 310 manufactured by ACME can request an authorization token 330 to load a module 340 prepared by a particular developer (Alice). The requested authorization token 330 can ensure that only a single person (Bob) can load the module 340 prepared by Alice onto secure device 310, even if secure device 310 is lost or stolen after Bob has loaded the module 340 into, e.g., firmware memory 316, of secure device 310. The field engineer/quality assurance engineer can then use the authorization token 330 to load module 340 prepared by the particular developer into, e.g., firmware memory 316, of secure device 310.

To load module 340 into, e.g., firmware memory 316, of secure device 310, the field engineer, quality assurance engineer, or other type of system or entity may provide the authorization token 330 to secure device 310 via access requesting device 350. The authorization token 330 may be stored on secure device 310 to facilitate the field engineer/quality assurance engineer loading module 340 onto secure device 310.

To perform the loading of module 340 onto secure device 310, the authorization token 330 may include various data. Similarly, the module 340 may include various data.

The authorization token 330 may include one or more of a secure device identifier 360, access token identifier 365, set of permissions 370, password identifier 375, encrypted symmetric key 380, public key identifier 385, and cryptographic signature 390.

The authorization token 330 may include secure device identifier 360. Secure device identifier 360 may represent the secure device 310 that the authorization token 330 is being placed on. Secure device identifier 360 may be an identifying characteristic related to secure device 310. For example, secure device 310 may be associated with a serial number to distinguish it from other secure devices 310. The secure device identifier 340 may be this specific serial number. When secure device 310 receives an authorization token 330, secure device 310 may check authorization data stored in firmware memory 316 to determine if the authorization token 330 includes the serial number as an identifier in secure device identifier 360. If so, secure device 310 may grant access to the device requesting access and/or providing the authorization token 330 to secure device 310 (e.g., access requesting device 350).

The authorization token 330 may include access token identifier 365. Access token identifier 350 may specify a user or access requesting device 350 attempting to load a module 340 on secure device 310. For example, access token identifier 365 may be an identification that a user has been properly authenticated at access requesting device 350, such as, for example, via a username and/or password authentication process. Access requesting device 350 may submit this user identification information as an access token identifier 350 in authorization token 330. In this manner, secure device 310 may utilize this information in conjunction with the authorization data stored in firmware memory 316 to determine whether to grant access to access requesting device 350. Access token identifier 350 may also include information related to access requesting device 350. For example, access token identifier 350 may include a serial number and/or key code associated with access requesting device 350. Secure device 310 may store this serial number and/or key code in firmware memory 116. When secure device 310 receives authorization token 330, it may determine whether the access token identifier 350 is stored in firmware memory 316.

The authorization token 330 may include set of permissions 370. Set of permissions 370 may include an indication of which firmware-locked functions (e.g., device specific or module specific) that secure device 310 should allow in response to receipt of authorization token 330. For example, after authentication and/or authorization based on authorization data stored in firmware memory 316, secure device 310 may utilize set of permissions 370 to determine one or more firmware-locked functions to unlock for use by access requesting device 350. Set of permissions 370 may include device permissions (e.g., which firmware-locked functions that secure 310 should allow in response to receipt of authorization token 330). Set of permissions 370 may include application permissions (e.g., permissions indicating what an associated module 340 can do).

In some embodiments, authorization token 330 may not include set of permissions 370. Instead, secure device 310 may determine which firmware-locked functions to unlock in response to authenticating authorization token 330 using authorization data stored in firmware memory 316. For example, firmware memory 316 may store and/or map available permissions to authorization token identifiers stored in the authorization data. In this manner, when secure device identifier 340 and/or access token identifier 350 are found to match authorization data stored in firmware memory 116, secure device 310 is able to identify which firmware-locked functions to unlock based on a mapping of permissions in firmware memory 316. In this manner, due to the mapping in firmware memory 316 between authorization token identifiers and permissions, authorization token 330 may not include set of permissions 370.

The authorization token 330 may include password identifier 375. Password identifier 375 may include an identifier associated with the entity (e.g., person or system) who is modifying the secure device 310 (e.g., loading the module(s) 340). Password identifier 375 may be a hash of the password associated with the entity who is modifying the secure device 310. The hash may be generated using a hashing function such as the MD5 message-digest algorithm, Secure Hash Algorithm 1 (SHA-1), or other types of hashing algorithms as would be appreciated by a person of ordinary skill in the art. For example, in the above example, the password identifier 375 may be a hash of the password of quality assurance engineer Bob who is loading module(s) 340 into firmware memory 116 of the secure device 310. Password identifier 375 may also be a hash of a PIN or other type of secret associated with the entity who is modifying the secure device 310 as would be appreciated by a person of ordinary skill in art.

The authorization token 330 may include encrypted symmetric key 380. Encrypted symmetric key 380 may be an encrypted version of a symmetric cryptographic key used to encrypt module 340. The symmetric cryptography key may be an Advanced Encryption Standard (AES) key or other type of cryptography key as would be appreciated by a person of ordinary skill in the art. Encrypted symmetric key 380 may be encrypted according to one or more secret data items on secure device 310 as would be appreciated by a person of ordinary skill in the art.

The authorization token 330 may include public key identifier 385. Public key identifier 385 may be per authorization token 330. Public key identifier 385 may be for a person or entity (e.g., a quality assurance engineer Bob) who asked for the authorization token 330 in order to load a module 340 prepared by a developer or other entity (e.g., a developer Alice) into firmware memory 116 of a secure device 310. Public key identifier 385 may be an identifier associated with the developer or entity who prepared the module 340. For example, public key identifier 385 may be a hash of the public cryptographic key associated with the person or entity who prepared the module(s) 340 for the secure device 310. The public cryptographic key associated with the person or entity who prepared the module(s) 340 for the secure device 310 may be a Rivest-Shamir-Adleman (RSA), Elliptic Curve Digital Signature Algorithm (ECDSA), or other type of public key as would be appreciated by a person of ordinary skill in the art. For example, in the above example, the public key identifier 385 maybe a hash of the public key of developer Alice who prepared the module(s) 340 for the secure device 310.

The authorization token 330 may include a cryptographic signature 390. Cryptographic signature 390 may be used to check whether the authorization token 330 is authentic and whether tampering with authorization token 330 has occurred. Cryptographic signature 390 may be generated by authorization service 320 by signing the authorization token 330 with the private cryptographic key corresponding to the public key associated with public key identifier 385. For example, cryptographic signature 390 may be generated by authorization service 320 by signing the authorization token 330 with the private key corresponding to the public key of the developer Alice associated with authorization token 330. This can ensure that the authentication token 330 is authentic, e.g., the authorization 330 really represents an authorization for Bob to load modules on secure device 310 from Alice.

To further perform the loading of module 340 onto secure device 310, the module 340 may include a header indicating whether the module is a production module or development module. The module 340 may also include a cryptographic signature. The cryptographic signature may be generated using the private key corresponding to the public key identifier 385 in the authorization token 330. In other words, module 340 may be signed with the private key of the developer Alice associated with authorization token 330. The cryptographic signature may be used to check whether the module 340 is authentic and whether tampering with module 340 has occurred.

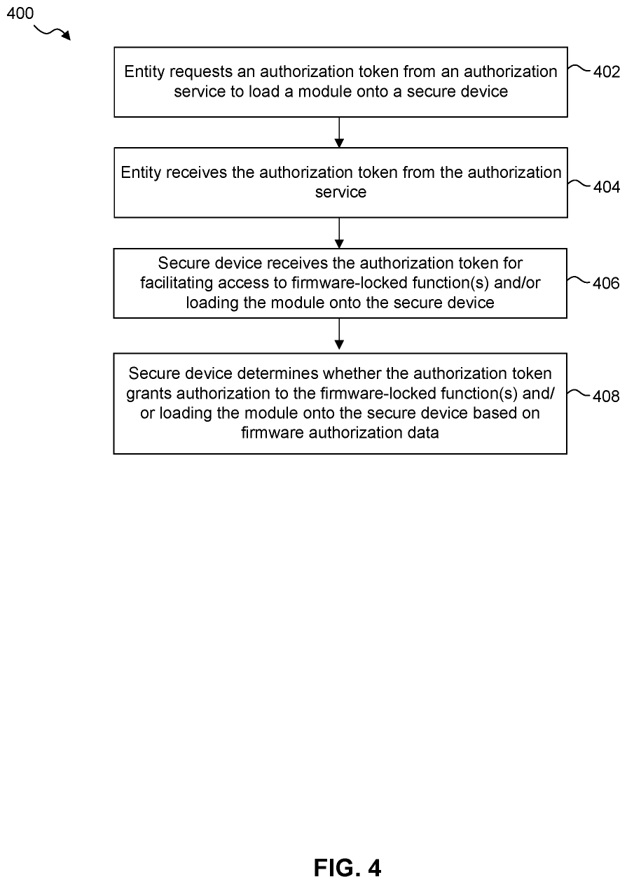

FIG. 4 is a flowchart for a method 400 for requesting and loading an authorization token onto a secure device to facilitate access to secure device function and/or loading a module, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIG. 3. However, method 400 is not limited to that example embodiment.

In 402, a user or entity (e.g., via access requesting device 350) requests an authorization token 330 from authorization service 320 to facilitate loading a module 340 onto a secure device 310. Authorization service 320 can generate the authorization token 330 such that it is specific to the requesting user or entity who is interested in loading a module 340 prepared by a specific other user or entity onto the secure device 310.

For example, a field engineer (Bob) who tests and/or troubleshoots secure device 310 manufactured by ACME can request an authorization token 330 to load modules 340 prepared by a particular developer (Alice) from the authorization service 310. The authorization service 310 can generate an authorization token 330 that ensures that only a single person (Bob) can load the module 340 prepared by Alice onto secure device 310, even if secure device 310 is lost or stolen after Bob loaded the module 340 into firmware memory 316 of secure device 310. The field engineer/quality assurance engineer can then use the authorization token 330 to load module 340 prepared by the particular developer into firmware memory 316 of secure device 310.

In 404, the user or entity (e.g., via access requesting device 350) receives the generated authorization token 330 from authorization service 320.

In 406, secure device 310 receives the authorization token 330 for facilitating access to firmware-locked function(s) and/or loading modules 340 onto secure device 310. Secure device 310 may receive authorization token 330 from access requesting device 320.

In 408, secure device 310 determines whether the received authorization token 330 grants authorization to the firmware-locked function and/or loading modules 340 onto secure device 310 based on firmware authorization data. Secure device 310 may analyze the received authorization token 330 to determine whether authorization token 330 includes an identifier that matches an identifier stored in the authorization data. For example, secure device 310 may determine whether authorization token 330 includes a secure device identifier 360 and/or an access token identifier 365 that matches authorization data stored in firmware memory 316. Secure device 110 may examine whether other conditions are met based on information stored in secure device identifier 360. For example, secure device 310 may examine firmware version information included in secure device identifier 360 to determine if firmware version information included in an authorization token 330 matches the firmware version of secure device 310. Secure device 310 may also compare firmware build date information, time limits stored in secure device 310 and/or specified by authorization token 330, and/or token signature information.

If secure device 310 in 408 determines that the received authorization token 330 grants authorization, secure device 310 may allow an entity to use the authorization token 330 to access a firmware-locked function and/or to loading a module 340 onto secure device 310. For example, secure device 310 may allow an entity to use the authorization token 330 to load a module 340 onto secure device 310 according to method 500 as described below.

If secure device 310 in 408 determines that the received authorization token 330 does not grant authorization, secure device 110 may deny access to a firmware-locked function and/or to loading a module 340 onto secure device 310. For example, secure device 310 may continue to prevent access and/or may notify access requesting device 350 that access has been denied. Secure device 310 may generate an alert to a third party system indicating that an unauthorized system has attempted to access the firmware-locked function and/or attempted to load a module 340 onto secure device 310. This alert may be a message and/or a push notification and may indicate an attempt at tampering with secure device 310. In response to denying access to the firmware-locked function and/or to loading a module 340 onto secure device 310, secure device 310 may disable other features of secure device 310 to prevent further attempts at access. For example, secure device 310 may disable access to application programs. If a user attempting to hack or reverse engineer secure device 310 fails to access the firmware-locked function, secure device 310 may enter a security state that locks functionality to prevent further tampering. The security state may be disabled and/or access to the locked application programs may be enabled by the proprietor or manufacturer of secure device 310.

FIG. 5 is a flowchart for a method 500 for allowing a first entity to load a module prepared by a second entity on a secure device without allowing other users to access secure functions or load another module on the secure device if the secure device is lost or stolen, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIGS. 3 and 4. However, method 400 is not limited to those example embodiments.

In 502, secure device 310 optionally receives, from a first entity (e.g., user or system), a request to load a module 340 prepared by a second entity (e.g., user or system) onto the secure device 310. Secure device 310 may receive the request during boot-up of the secure device 310. Secure device 310 may also receive the request during run-time of the secure device 310.

In 504, secure device 310 receives a secret (e.g., a password) from the first entity in order to load the module 340 onto the secure device 310. The request for the secret (e.g., a password) from the first entity to load the module 340 onto the secure device 310 may be in response to receiving the request to load the module 340.

In 506, secure device 310 determines whether the secret (e.g., password) matches a password identifier 375 in an authorization token 330 stored on the secure device 310. The authorization token 330 may be loaded ahead of time onto the secure device 310 according to method 400. The authorization token 330 may be loaded ahead of time onto the secure device 310 using various other mechanisms as would be appreciated by a person of ordinary skill in the art.

The authorization token 330 can be specific to the requesting first entity who is interested in loading the module 340 prepared by the second entity onto the secure device 310. Authorization service 320 can generate the authorization token 330 as discussed above.

In 508, secure device 310 retrieves a public key based on a public key identifier 385 in the authorization token 330. Secure device 310 can retrieve the public key in response to secure device 310 determining the secret (e.g., password) matches the password identifier 375 in the authorization token 320 in 506. The public key may be stored on the secure device 310. The pubic key can correspond to the second entity.

In 510, secure device 310 optionally verifies cryptographic signature 390 in the authorization token 330. Cryptographic signature 390 may have been generated by authorization service 320 by signing the authorization token 330 with the private cryptographic key corresponding to the public key associated with the public key identifier 385. Secure device 310 may verify cryptographic signature 390 in the authorization token 330 using the public key associated with the public key identifier 385.

In 512, secure device 310 decrypts an encrypted symmetric key 380 in the authorization token 330, thereby producing a decrypted symmetric key. Secure device 310 may decrypt the encrypted symmetric key 380 in the authorization token 330 in response to verifying the cryptographic signature 390 in the authorization token 330 in 510. For example, secure device 310 may decrypt the encrypted symmetric key 380 in the authorization token 330 using one or more secrets on the secure device 310. In some embodiments, secure device 310 may decrypt the encrypted symmetric key 380 using a special derived key on the secure device 310.

In 514, secure device 310 decrypts the module 340 using the decrypted symmetric key.

In 516, secure device 310 loads the module 340 onto secure device 310. Secure device 310 may load the module 340 onto secure device 310 in response to a successful decryption of the module 340.

Secure device 310 may access one or more locked functions (e.g., locked firmware functions) to load the module 340. Secure device 310 may access the one or more locked functions using the authorization token 330.

Secure device 310 my load the module 340 onto the secure device 310 differently (e.g., allow, block, or allow the loading and running of the module 340 on secure device 310 subject to various operational conditions) depending on a header data structure in the module 340. The header data structure in the module 340 may indicate whether the module 340 is a development module (e.g., unsuitable for production use) or a production module (e.g., suitable for production use in the field). The header data structure may specify various other rules or conditions for loading the module 340 on secure device 310 as would be appreciated by a person of ordinary skill in the art.

In 518, secure device 310 may optionally determine whether to allow module 340 to perform certain functions (e.g., access a firmware-locked function in the secure device 310 or perform an application-level function in the secure device 310) based on a set of permissions 370 in the authorization token 370. The set of permissions 370 may indicate the one or more firmware-locked functions available to access by the module 340. The set of permissions 370 may indicate the manner in which the module 340 may interact with the firmware-locked function.

Secure device 310 may determine whether to allow module 340 to perform certain functions on a temporary basis or on a permanent basis based on the set of permissions 370 in the authorization token 370. For example, secure device 310 may allow module 340 to perform certain functions on a temporary basis based on the authorization token 330 expiring based on a certain time limit. Secure device 310 may allow module 340 to perform certain functions on a temporary basis based on the authorization token 330 being tied to a specific session established between secure device 310 and access requesting device 350. When the session expires, secure device 310 may request that access requesting device 350 provide the authorization token 330 again to access certain functions (e.g., access a firmware-locked function in the secure device 310 or perform an application-level function in the secure device 310).

### Example Computer System

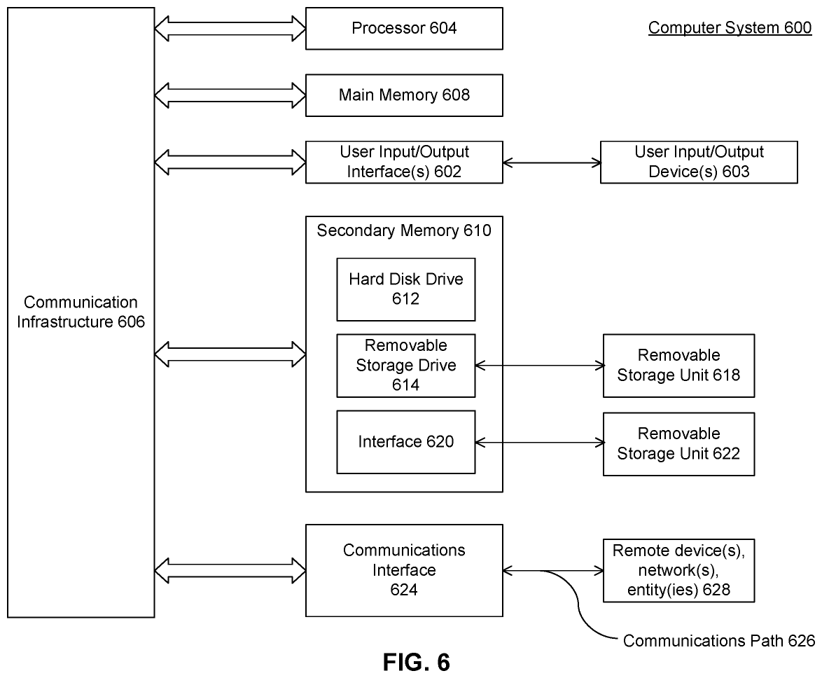

Various embodiments may be implemented, for example, using one or more well-known computer systems, such as computer system 600 shown in FIG. 6. For example, the media device 106 may be implemented using combinations or sub-combinations of computer system 600. Secure device 310 may be implemented using combinations or sub-combinations of computer system 600. Also or alternatively, one or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JSON, Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600 or processor(s) 604), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for allowing a first entity to securely load a module prepared by a second entity on a secure device, comprising:
receiving, by at least one computer processor at the secure device from the first entity, a request to load the module prepared by the second entity on the secure device;
in response to receiving the request, receiving a password from the first entity in order to load the module onto the secure device;
determining the password matches a password identifier in an authorization token stored on the secure device;
in response to determining the password matches the password identifier in the authorization token, retrieving a public key from the secure device based on a public key identifier in the authorization token;
verifying a cryptographic signature of the module using the public key;
in response to verifying the cryptographic signature of the module, decrypting an encrypted symmetric key in the authorization token using one or more secrets on the secure device, thereby producing a symmetric key;
decrypting the module using the symmetric key; and
loading the module onto the secure device.

2. The computer-implemented method of claim 1, wherein the authorization token is generated by an authorization service on behalf of the first entity and the second entity.

3. The computer-implemented method of claim 1, further comprising:
loading the module onto the secure device according to a set of permissions in the authorization token.

4. The computer-implemented method of claim 1, wherein the loading comprises:
loading the module onto the secure device according to a header in the module that specifies whether the module is a development module or a production module.

5. The computer-implemented method of claim 1, wherein the authorization token is a JavaScript Object Notation (JSON) Web Token data structure.

6. The computer-implemented method of claim 1, further comprising:
receiving, from an access requesting device, the authorization token, wherein the authorization token is specific to the first entity loading modules prepared by the second entity, and the authorization token comprises a secure device identifier.

7. The computer-implemented method of claim 6, further comprising:
comparing the secure device identifier included in the authorization token to authorization data stored in a memory of the secure device, wherein the authorization data includes the secure device identifier; and
determining that the secure device identifier included in the authorization token matches the secure device identifier from the authorization data.

8. A secure device, comprising:
one or more memories; and
at least one processor each coupled to at least one of the memories and configured to perform operations comprising:
receiving, at the secure device from a first entity, a request to load a module prepared by a second entity on the secure device;
in response to receiving the request, receiving a password from the first entity in order to load the module onto the secure device;
determining the password matches a password identifier in an authorization token stored on the secure device;
in response to determining the password matches the password identifier in the authorization token, retrieving a public key from the secure device based on a public key identifier in the authorization token;
verifying a cryptographic signature of the module using the public key;
in response to verifying the cryptographic signature of the module, decrypting an encrypted symmetric key in the authorization token using one or more secrets on the secure device, thereby producing a symmetric key;
decrypting the module using the symmetric key; and
loading the module onto the secure device.

9. The secure device of claim 8, wherein the authorization token is generated by an authorization service on behalf of the first entity and the second entity.

10. The secure device of claim 8, wherein the operations further comprise:
loading the module onto the secure device according to a set of permissions in the authorization token.

11. The secure device of claim 8, wherein the loading comprises:
loading the module onto the secure device according to a header in the module that specifies whether the module is a development module or a production module.

12. The secure device of claim 8, wherein the authorization token is a JavaScript Object Notation (JSON) Web Token data structure.

13. The secure device of claim 8, wherein the operations further comprise:
receiving, from an access requesting device, the authorization token, wherein the authorization token is specific to the first entity loading modules prepared by the second entity, and the authorization token comprises a secure device identifier.

14. The secure device of claim 13, wherein the operations further comprise:
comparing the secure device identifier included in the authorization token to authorization data stored in a memory of the secure device, wherein the authorization data includes the secure device identifier; and
determining that the secure device identifier included in the authorization token matches the secure device identifier from the authorization data.

15. A non-transitory computer-readable medium having instructions stored thereon that, when executed by at least one computing device, cause the at least one computing device to perform operations comprising:
receiving, at the at least one computing device from a first entity, a request to load a module prepared by the second entity on a secure device;
in response to receiving the request, receiving a password from the first entity in order to load the module onto the secure device;
determining the password matches a password identifier in an authorization token stored on the secure device;
in response to determining the password matches the password identifier in the authorization token, retrieving a public key from the secure device based on a public key identifier in the authorization token;
verifying a cryptographic signature of the module using the public key;
in response to verifying the cryptographic signature of the module, decrypting an encrypted symmetric key in the authorization token using one or more secrets on the secure device, thereby producing a symmetric key;
decrypting the module using the symmetric key; and
loading the module onto the secure device.

16. The non-transitory computer-readable medium of claim 15, wherein the authorization token is generated by an authorization service on behalf of the first entity and the second entity.

17. The non-transitory computer-readable medium of claim 15, wherein the operations further comprise:
loading the module onto the secure device according to a set of permissions in the authorization token.

18. The non-transitory computer-readable medium of claim 15, wherein the loading comprises:
loading the module onto the secure device according to a header in the module that specifies whether the module is a development module or a production module.

19. The non-transitory computer-readable medium of claim 15, wherein the operations further comprise:
receiving, from an access requesting device, the authorization token, wherein the authorization token is specific to the first entity loading modules prepared by the second entity, and the authorization token comprises a secure device identifier.

20. The non-transitory computer-readable medium of claim 19, wherein the operations further comprise:
comparing the secure device identifier included in the authorization token to authorization data stored in a memory of the secure device, wherein the authorization data includes the secure device identifier; and
determining that the secure device identifier included in the authorization token matches the secure device identifier from the authorization data.
